(19) United States
(12) Patent Application Publication
(10) Pub. No.: US 2014/0060342 A1
(43) Pub. Date: Mar. 6, 2014

(54) Mould (Mold) for fast and easy shaping a ingredients of kebab, hamburger and other

(71) Applicant: ALBERT RUSSELL, Torrance, CA (US)

(72) Inventor: ALBERT RUSSELL, Torrance, CA (US)

(21) Appl. No.: 13/915,629

(22) Filed: Jun. 12, 2013

Related U.S. Application Data
(60) Provisional application No. 61/661,783, filed on Jun. 19, 2012.

(51) Int. Cl. A47J 43/20

(52) U.S. Cl. CPC A47J 43/20
USPC 99/426; 249/117; 99/516

(57) ABSTRACT

Invention title: Mould (Mold) for fast and easy shaping a ingredients of kebab, hamburger and other* *: this Mould can be use the Revolution of preparation and cooking process that is invented by Albert Russell Purpose of Invention: Reduce the time and cost of preparing Kebab, special koobide. Mould (Mold) is avoid very difficult preparing of kebab (koobide) that need skewer. That is save time, save a space for keeping in refrigerating, possibility to prepare mass and without special train. or experience, less cooking stuff, eliminate skewer, easy to extend. Mould (Mold) can be any kind of shape, and material.

Invention used: for any food and kebab spacial for Kebab koobide, can be used in fast food, restaurant, mass production, food truck, businesses and other and that create a lot of job, reduce the food cost

Describe the main components and how they work: how easy can prepare kebab

U.S. Patent Documents

| | | |
|---|---|---|
| 1,358,365 | November 1920 | De Matteis |
| 3,956,979 | May 1976 | Coroneos |
| 4,018,145 | April 1977 | Hensel |
| 4,300,443 | November 1981 | Morcos et al. |
| 4,512,248 | April 1985 | Volakakis |
| 5,121,677 | June 1992 | Le Claire et al. |
| 5,357,853 | October 1994 | Nelson et al. |
| 5,473,979 | December 1995 | Ruben |
| 5,546,848 | August 1996 | Naramura |
| 5,921,170 | July 1999 | Khatchadourian et al. |

### CROSS REFERENCE TO RELATED APPLICATION

This non-provisional patent application claims the benefit of provisional application Ser. No. 61/661,783 filed on Jun. 19, 2012 titled Mould (mold) Kit for ingredients shaping for fast and easy cooking, can be use for different kind of food and or different kind of food and or kebab, hamburger and other, koobide and hamburger

### TECHNICAL FIELD OF THE INVENTION

This invention relates to a food producing machine, food preparation process, per-ready kit for food and or different kind of food and or kebab, hamburger and other, and particularly to a process and or machine to preparation a different kind of kebab, hamburger and other and food.

### BACKGROUND OF THE INVENTION

A kebab, hamburger and other is generally understood to be a series of food items skewered on a stick which is then typically cooked over a stove or barbecue. The typical different kind of food and or kebab, hamburger and other includes meat; such as beef and chicken, vegetables such as onions, peppers and the like, and any other food items desired.

A significant and growing market is the production of kebab, hamburger and others within a mass production setting. The kebab, hamburger and others are then refrigerated or frozen and distributed to stores for sale to customers. Customers find these items to be very desirable as the customer just take the kebab, hamburger and other from its appropriate packaging and begin the cooking processing or customer can purchase Mould (mold) kit and make kebab, hamburger and other at home with own ingredients (customers don't need to purchase the particular food items, cut them to the desired shape and skewer them on a stick).

Mould (mold) kit method, has more an efficient and an effective apparatus and method for producing these kebab, hamburger and others in a mass production environment.

### Traditional Method:

Ingredients: Mix ingredients need to get tube around Skewer with hand (maybe machine),
Problems: that takes time and have to be good experience or train to do that, otherwise, can be drop during moving or cooking.
Refrigerating: Leave it on the refrigerating to marinate for couple hours or overnight
Problems: These some problems:
As ingredients attached to skewers, skewers hand, and you have to use based for put skewers top of each other;
Take more space in refrigerator
Usage more energy

### Cooking: Steps:

Take some skewers from refrigerator for cooking
Leave them on the gas oven or BBQ
Has to be chief or some stay close to them, to turn it over after couple minutes to make sure both side cooked and not burn
   Problems: These some problems:
Watchman need to be close to skewer to check them
Has to use gas oven or BBQ
Has to be hire someone with good experience or train a lot to make sure kebab is cooked very well ant born or not cooked
Cooked degree is measure based on the experience and check with eyes Cook time is based on the distance of skewer with fire and size the fire and other conditions

### Revolution Method:

Ingredients: Mix ingredients put on the mould

Result: here are some improvement:
Very fast
No need any experience
Can be done mass-product
Can be any size, and shape
Can be done for any ingredient
   Refrigerating: Leave it on the refrigerating to marinate for couple hours or overnight
   Result: here are some improvement:
Less space
Less energy usage
Easy to take it out

### Cooking: Steps:

Take some mould(s) from refrigerator for cooking
Leave them on any oven or grill, or BBQ or heating system, gas or electrical
   Result: here are some improvement:
Very fast cooking
Can be set timer to make sure cooked completely
No need any experience
Cooked degree is measure based on the timer
Cook time is based on the distance on heating degree
No watchman need it

### FIELD OF THE INVENTION

The present invention relates to a method for preparation of different kind of food and or kebab, hamburger and other within the speed, and standards required by a fast food system and an integrated ingredients shaping instrument for achieving this method.

In the conventional method there are some boring and hard steps such as:
1. Mixing step: an ingredients need to be mix and press on the big carrier
2. Squeeze step: Then with human hand needs to be squeeze around skewers. This is very critical and timely manner task because:
   1. The person wants to do that, has to be trained and strong experience
   2. Some issues happen with negligent this process would be:
      1. Ingredients will be fall down from skewer during preparation
      2. Ingredients will be fall down from skewer during keep on the refrigerator
      3. Ingredients will be fall down from skewer during cooking over barbecue (BBQ), oven and other cooking method
      4. This is very hard and timely manner step
3. Cooking step: in this step, someone needs to take skewer from refrigerator and leave it on the barbecue (BBQ), oven or other cooking device for cooking.
   1. Note: as use skewer, cooking device has to be kind of bar to hold both end of skewer, to make sure ingredients not stick to cooking device and usually cooking device is horizontal, some issues may happen as well such as:
      1. Ingredients may fall down, therefore, someone needs to watch it out and turn over every couple minutes or less
      2. Ingredients may burn out, therefore, someone needs to watch it out and turn over every couple minutes or less.
      3. Ingredients may stick on skewer, therefore, someone needs to watch it out and push ingredients over skewer at least two times

### Conventional Method Issues:

1. This process needs special equipments and that is cause, eliminate to extend to new market and locations also create small food locations
2. This process needs trained and experienced people, that cause not only increase cost of operations but also hard to find someone with good experiences in market
3. This process can't be extend to home preparation food market

This process is very hard and timely manner and would be very hard to cooking a lot of different kind of food and or kebab, hamburger and other same time
4. Require special chief
5. More equipment
6. Costly, slow and timely
7. and so many other issues
8. So hard to extend
9. conventional method can not be have these advantages:
   1. Sales on the shelf
   2. Sale on the freezing package
   3. Sales on the truck food
   4. Sales on the mass-market
   5. Mass-product

### SUMMARY OF THE INVENTION

The field of the invention and the manual technique for fast preparation process for making different type of food and or kebab, hamburger and other and fast food is known.

The present invention provides mould (mold) Kit for ingredients shaping as described herein below; all of the process of the invention can be controlled and do it with machine and or human and can be use any kind of frame for ingredients shaping such as mould (mold) to shape the ingredients to make different kind of food and or kebab, hamburger and other in different shape such as long, circle, rectangular, or other shaped based on packaging, serving plan, and or bread or other factors.

“A Mould (Mold), ingredients shaping ingredients: Any kind of shape any kind of size can be use for food industries to shape ingredients to be ready for cook, per-cook and other purpose, also for mass-market and mass-product.”

As a result, all of the operations, either in small businesses or big ones could be carried out with or without direct human intervention in the less time, less operation cost, less human errors, less usage energy, and create a lot of job.

Mould (mold) Kit for ingredients shaping process can be use for any kind of different food and or kebab, hamburger and other, fast food, restaurant, mass production, food truck, businesses and other and that create a lot of job, with the reducing the cooking process food cost

“Less than a couple minutes prepare and cook”. After mix and prepare ingredients, take some and put on the mould (mold) and press it can be by hand or small press, then leave them on the refrigerator for couple hours, then take them for cooking and then ready to service. With this Mould (mold) Kit for ingredients shaping, easy use mould (mold) for ingredients shaping, no any more skewer.

This invention allows business, organizations, and individuals to have fast, economy and easy process of preparation and cooking different kind of food and or kebab, hamburger and other (kabab) and burger to avoid costly, slowly and timely process and labor effective process.

The Mould (mold) Kit for ingredients shaping cooking of the invention has so many advantages:
1. Fast process
2. Less equipment use
3. Without any specific knowledge
4. Less waste time and material
5. mass-product
6. mass-market
7. Economy and environment friendly
8. Create a lot of job for people they like be hired or they like to own business
9. Extended mass-market in food industry
10. Mass-product for sales on shelf
11. Improve economy and environment friendly
12. Can be use on restaurant, fast food, truck food, manufacturer, sales as freezing products, precooked products
13. Don't need to hire special chief
14. Less equipment
15. Less costly, fast and quick process and so many other issues
16. With a little a change in the process, can use this method for other type of processing and cooking, this save time and cost.
17. With short training, can be save a lot of time and reduce the cost in operation
18. Reduce the operation cost
19. Reduce the operation time
20. Reduce the equipments
21. Eliminate hire special chief
22. Eliminate skewer, fire and BBQ
23. Increase mass-market
24. Increase mass-product
25. Increase market by more place to serve such as restaurant, fast food, truck food
26. Easy and fast steps
27. Just couple minutes time, less time
28. Can be cooked on any kind of grill, oven, barbeque, BBQ, heating, and or electrical or gas
29. Can any one cooked with a little knowledge same as other hamburger
30. Can be done with less expedience and train
31. No need any special gas oven
32. No need any BBQ, or or other or special
33. No need special chief.
34. No need any extra stuff
35. Take kebab fro refrigerator
36. put on the surface of oven, or BBG, or other
37. You can turn oven same as other burger to make sure both side is cooked
38. Checked to make sure cooked

### BRIEF DESCRIPTION OF THE DRAWINGS

For a more complete understanding of the present invention and the advantages thereof, reference is now made to the following description taken in conjunction with the accompanying drawings, in which:

Preparation process would be same in Conventional process and Mould (mold) Kit for ingredients shaping process (FIGS. 1 to 5):

FIG. 1—Main ingredients: such as any kind of of ground meat, and or vegetable or meat alternatives

FIG. 2—Grinder Main ingredients

FIG. 3—Adding ingredients: such as onion, egg, salt, pepper. Mix meat, onions, egg, salt and pepper

FIG. 4—All Ingredients ready to mix

FIG. 5—Mix step: Mix main ingredients and adding ingredients

FIG. 6—V shape mould (mold) Kit for ingredients shaping process, use mould (mold) or other kind of ingredients shaping

FIG. 7—Octal shape mould (mold) Kit for ingredients shaping process, use mould (mold) or other kind of ingredients shaping

FIG. 8—Rectangular shape mould (mold) Kit for ingredients shaping process, use mould (mold) or other kind of ingredients shaping

FIG. 9—U shape mould (mold) Kit for ingredients shaping process, use mould (mold) or other kind of ingredients shaping

FIG. 10—V shape ingredients shaping in Mould (mold) Kit for ingredients shaping process, use mould (mold) or other kind of ingredients shaping

FIG. 11—Rectangular shape mould (mold) Kit for ingredients shaping process, use mould (mold) or other kind of ingredients shaping

FIG. 12—U shape mould (mold) Kit for ingredients shaping process, use mould (mold) or other kind of ingredients shaping

FIG. 13—U shape mould (mold) Kit for ingredients shaping process, use mould (mold) or other kind of ingredients shaping

FIG. 14—U shape mould (mold) Kit for ingredients shaping process, different type of mould (mold) or other kind of ingredients shaping

FIG. 15—Octal shape mould (mold) Kit for ingredients shaping process, different type of mould (mold) or other kind of ingredients shaping

FIG. 16—ingredients shaping in Mould (mold) Kit for ingredients shaping process, different type of ingredients shaping method such as use wrapping plastic or other kind of wrapping

FIG. 17—uncooked different kind of food and or kebab, hamburger and other on the refrigerator

FIG. 18—Oven: in this method can be use any kind of over oven, Electrical oven with one head or two head, fire, barbeque(BBQ), or other.

FIG. 19—Cooking process can use any kind of over oven

FIG. 20—Cooking process can use any kind of over oven, fire, barbeque(BBQ), or other.

FIG. 21—Ready to serve, with rice

FIG. 22—Ready to serve as sandwich

FIG. 23—Ready to serve as fast food

FIG. 24—Ready to serve as sandwich with other

### DETAILED DESCRIPTION OF MOULD (MOLD) KIT FOR INGREDIENTS SHAPING OF PREPARATION AND COOKING

Less than a couple minutes prepare and ready to cook.

After mix and prepare ingredients, leave on the refrigerator for couple hours, then cook them over oven, then ready to serve.

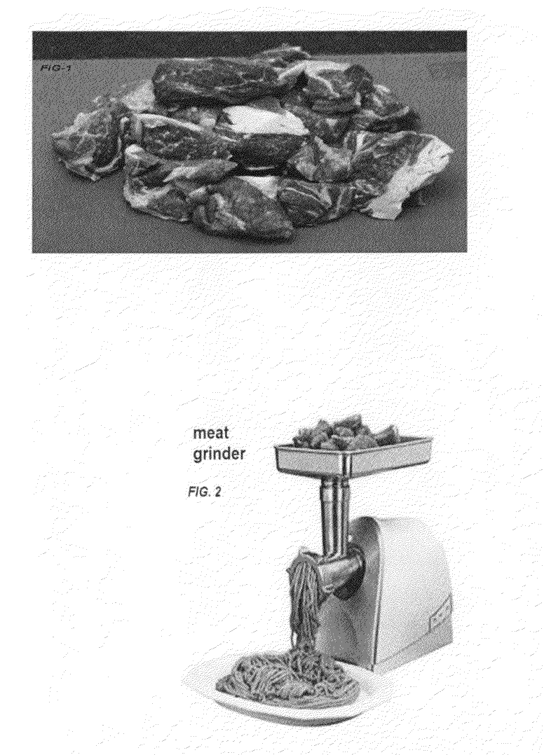

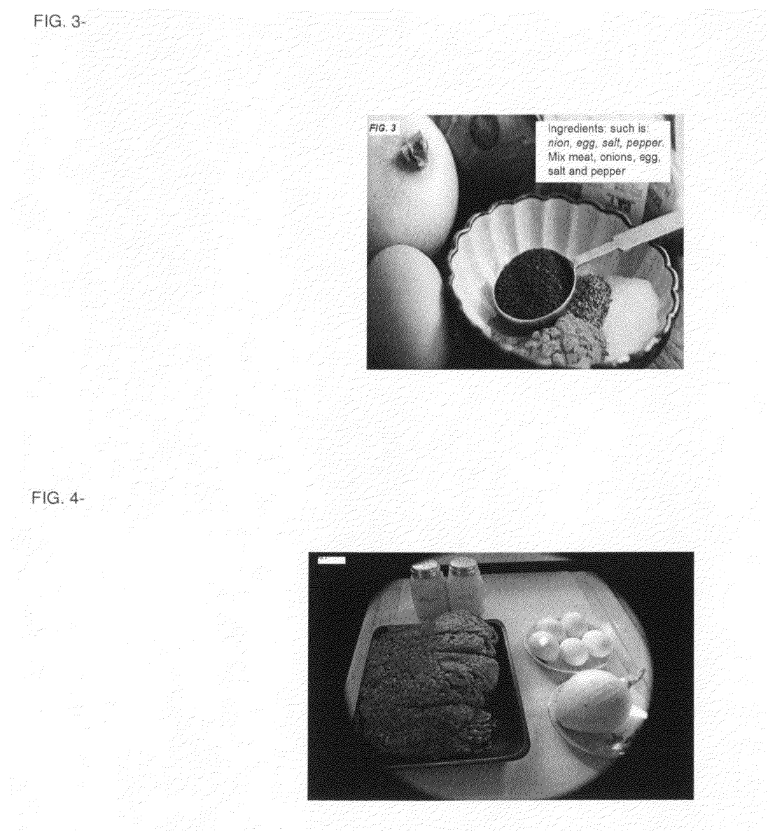

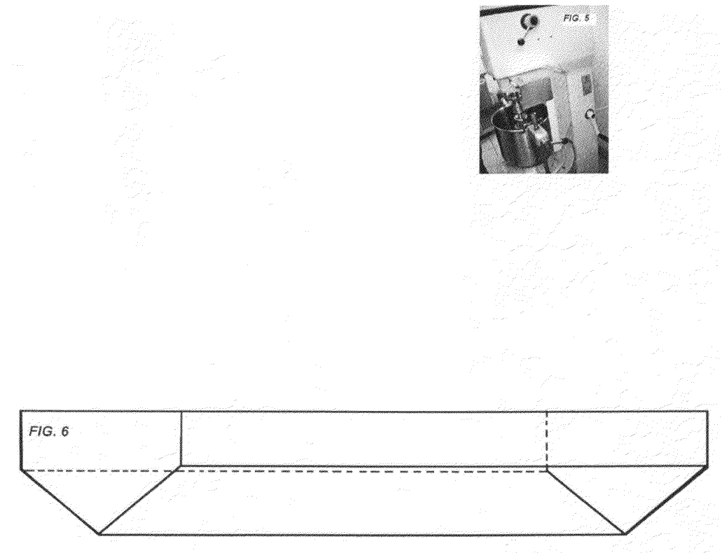

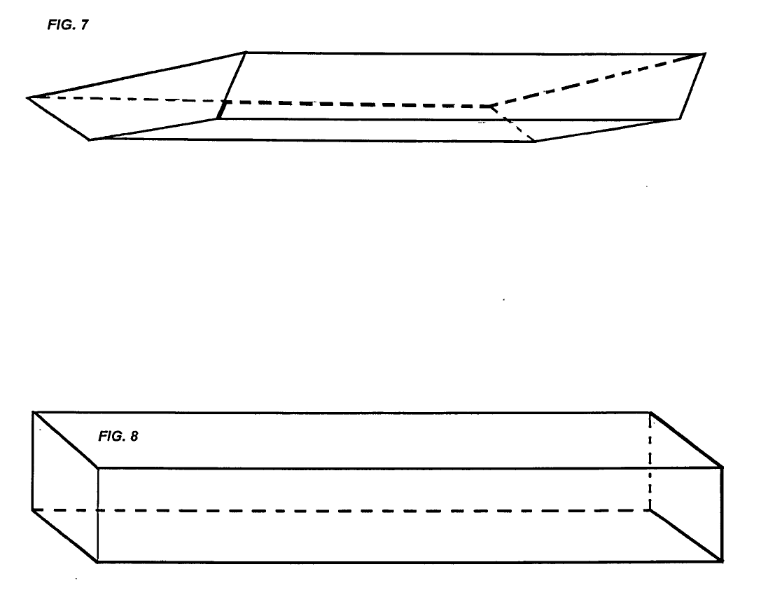

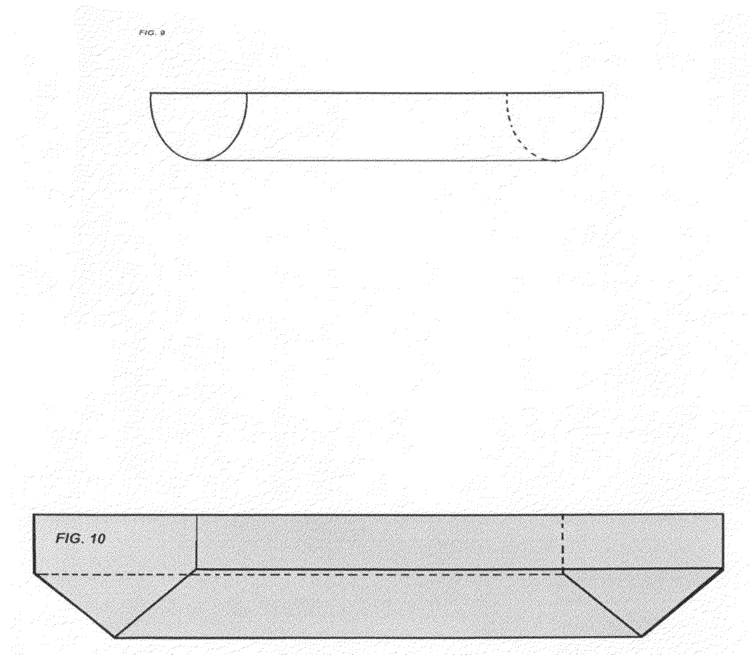

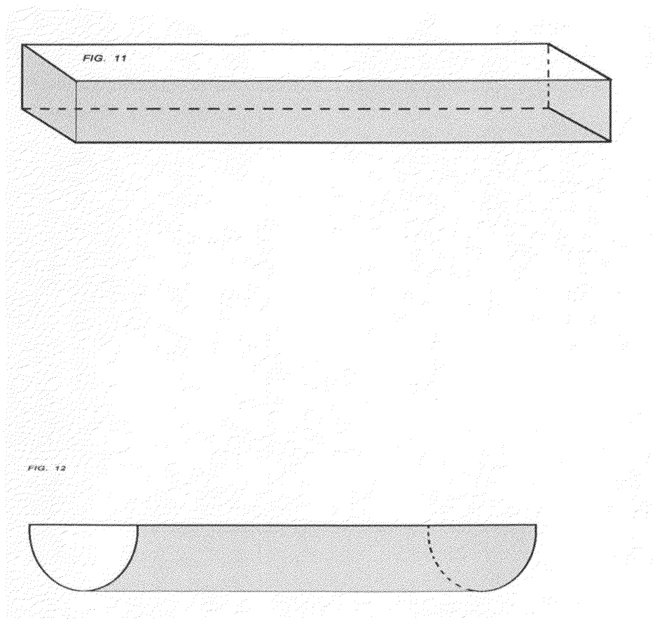

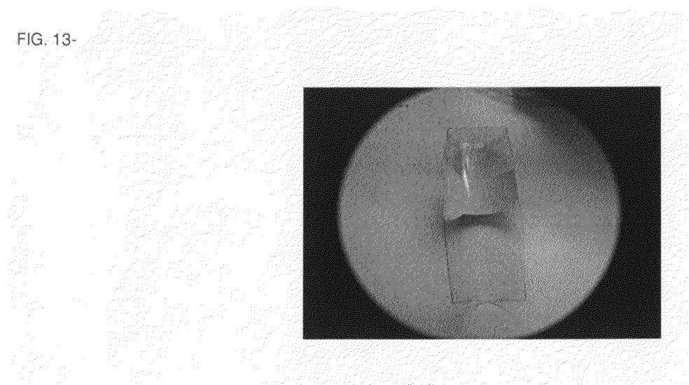

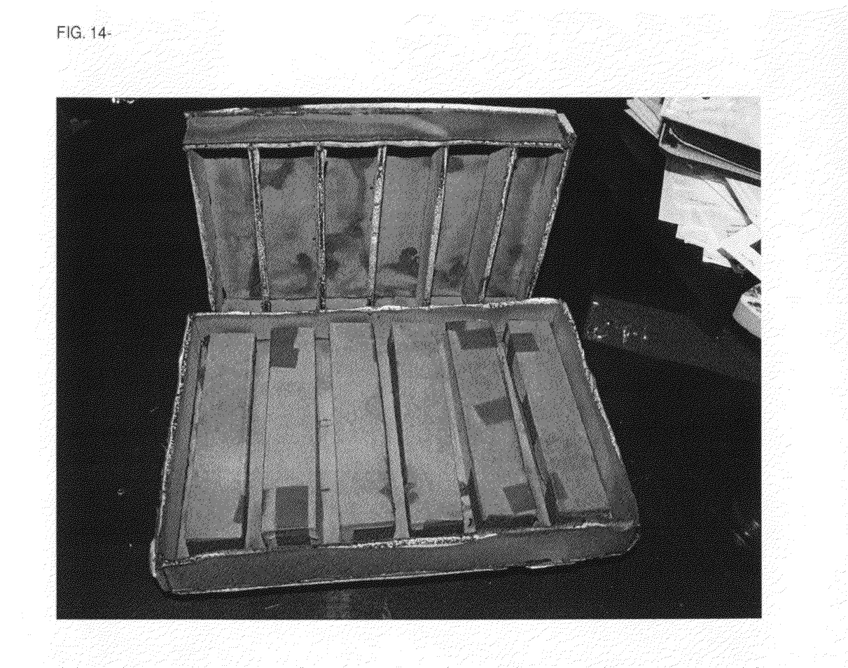

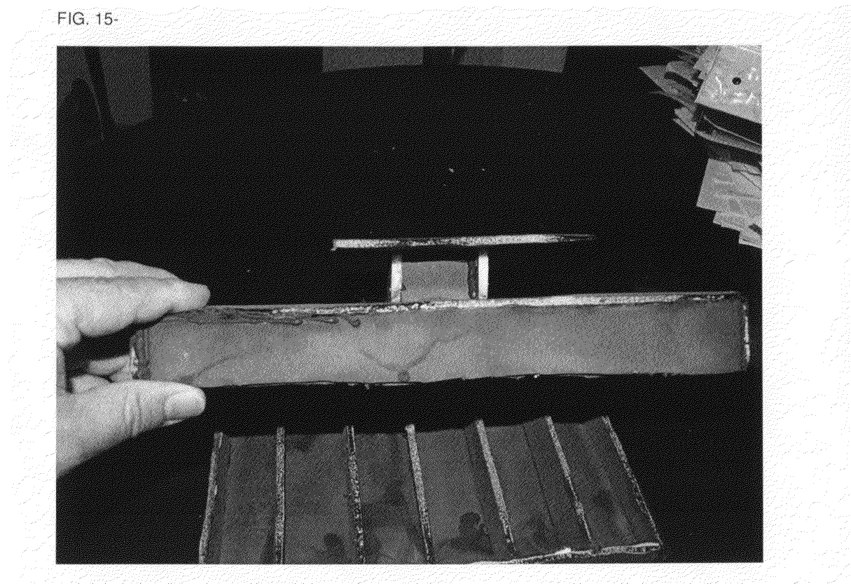

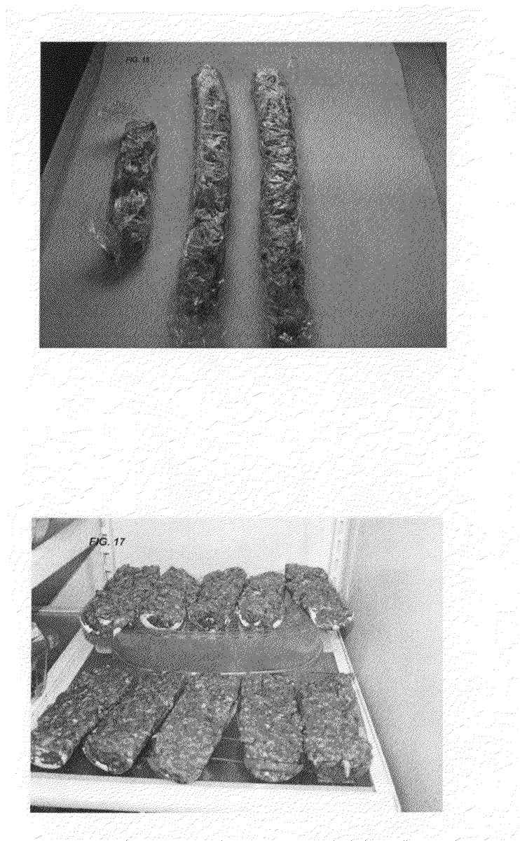

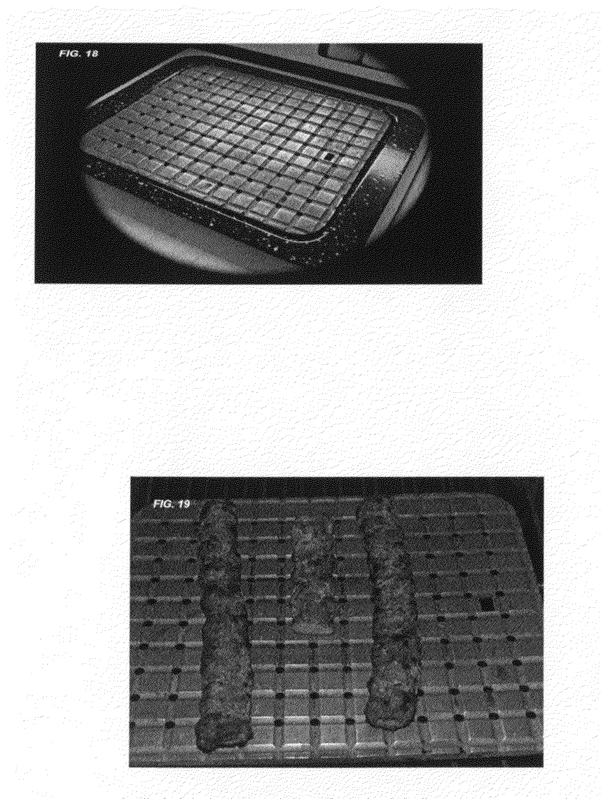

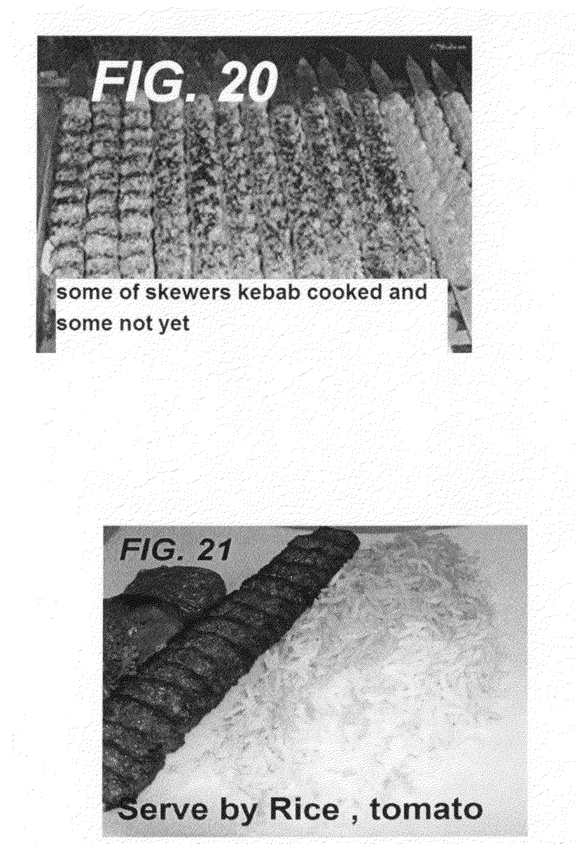

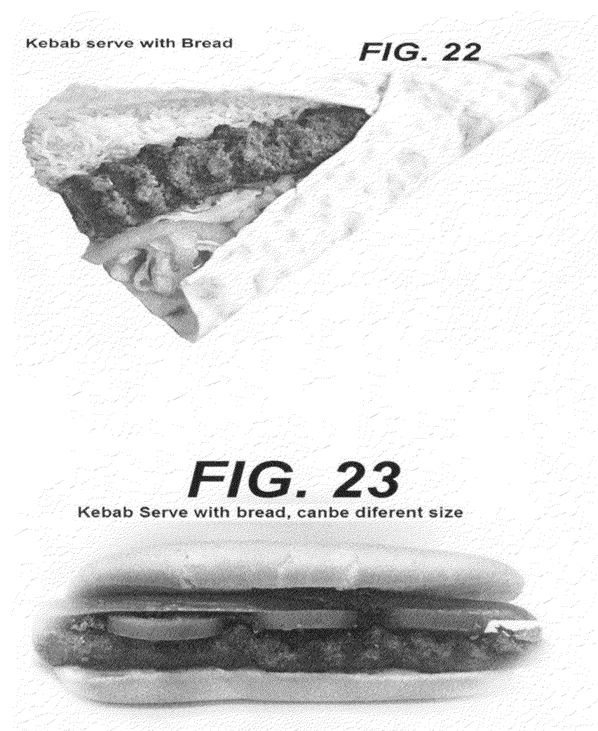

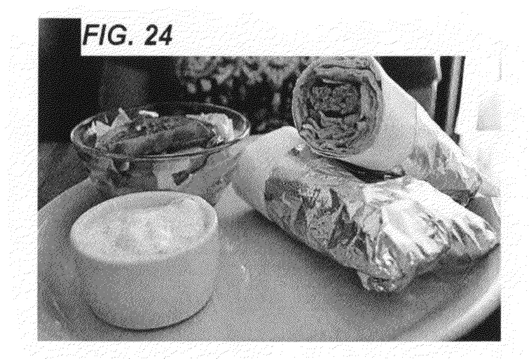

1—Preparation: Prepare main ingredients: can be any kind of of ground meat (can be beef, chicken, lamb or mix of them), and or vegetable or meat alternatives (FIG. 1), then ground them (FIG. 2) then prepare adding ingredients such as onion, egg, salt, pepper (FIG. 3). Then mix main ingredients with adding ingredients (FIG. 4 and FIG. 5), then keep it on refrigerator for couple hours to marinate
2—ingredients shaping: In this method, instead use skewer and hire special chief, use mould (mold) that cause use less time and it will be done less than couple minutes.
Now ingredients ready for ingredients shaping, take them from refrigerator and take some peaces based on the size of ingredients shaping you need (can be make 6″ and 12″ or any size), you can shaped with or without mould (mold) (FIG. 6, FIG. 7), long (FIG. 9, FIG. 10,), rectangular (FIG. 8), circle, or other shape (FIG. 11, FIG. 12, FIG. 13, FIG. 14, FIG. 15) or and use plastic as wrapped (FIG. 16), then keep it in refrigerator for couple hours (or overnight) (FIG. 18)
3—Cooking: For cooking process, can be use any kind of oven such as; regular oven (FIG. 18), barbecue, BBQ, fire, gas oven (FIG. 19), or double heat oven. (FIG. 20)
4—Serving: after cooked is done, different kind of food and or kebab, hamburger and other (kabab) or burger can be serve with different kind of beard such as; rice (FIG. 21), pita (FIG. 22), baguette (FIG. 23), sangak bread (FIG. 24), or other type.

| | | |
|---|---|---|
| 5,357,853 | October 1994 | Nelson et al. |
| 5,473,979 | December 1995 | Ruben |
| 5,546,848 | August 1996 | Naramura |
| 5,921,170 | July 1999 | Khatchadourian et al. |

The invention claimed are:

1. Mould (mold) Kit for ingredients shaping for obtaining cooked ready to serve different kind of food and or kebab, hamburger and other with different ingredients such as any kind of meat

2. Mould (mold) Kit for ingredients shaping for obtaining cooked ready to serve different kind of food and or kebab, hamburger and other with different ingredients such as any kind of meet, and or vegetables, and or sea food

3. An Mould (mold) Kit for ingredients shaping according to claims 1, 2 and 3, wherein: the ingredient ready-to-shape

4. An Mould (mold) Kit for ingredients shaping according to claim 4, wherein: the ingredient ready-to-shape can be use any kind of shape form such as plastic and or other type

5. An Mould (mold) Kit for ingredients ingredients shaping according to claim 1, 2, and 3, wherein: the ingredients ready-to-cook with packed

6. An Mould (mold) Kit for ingredients shaping according to claim 1, 2, 3, wherein: a cooking and cutting operation continues until a completion of take them form mould (mold) or containers for cooking.

7. An Mould (mold) Kit for ingredients shaping according to claims 1, 2 and 3, wherein: a pushing ingredients into mould (mold) then ready-to-marinate, and then leave it on refrigerator or any system can hold cold for couple hours

8. An Mould (mold) Kit for ingredients shaping according to claim 7, wherein: after refrigerated, ready-to-cook over any kind of heating or oven, barbeque, BBQ and other devices

9. An Mould (mold) Kit for ingredients shaping according to claim 10, wherein: can be cooked in different cooking degree of each cooker may be tuned according to the desired cooking degree over gas, electric and other devices.

10. An Mould (mold) Kit for ingredients shaping according to claims 1, 2 and 3, wherein: can be use for any kind of different food and or kebab, hamburger and other

11. An Mould (mold) Kit for ingredients ingredients shaping according to claims 1, 2 and 3, wherein: can be use for any kind of fast food, and or meet, and or seafood, and or any kind of sandwich, and or food processing, and or food serving, and or restaurant

12. An Mould (mold) Kit for ingredients shaping according to claims 1, 2 and 3, wherein: can be use in different location such as and or fast food and or food truck

13. An Mould (mold) Kit for ingredients shaping according to claims 1, 2 and 3, wherein: can be use in different location such as food preparation

14. An Mould (mold) Kit for ingredients shaping according to claims 1, 2 and 3, wherein: can be use in different location such as food mass-market

15. An Mould (mold) Kit for ingredients shaping according to claims 1, 2 and 3, wherein: can be use in different location such as food freezing processing

16. An Mould (mold) Kit for ingredients shaping according to claims 1, 2 and 3, wherein: can be use in different location such as preparing food

17. An Mould (mold) Kit for ingredients shaping according to claims 1, 2 and 3, wherein: can be use in different location such as food kiosk

18. An Mould (mold) Kit for ingredients shaping according to claims 1, 2 and 3, wherein: can be use in different location such as cafeteria

19. An Mould (mold) Kit for ingredients shaping according to claims 1, 2 and 3, wherein: can be use in different location such as food businesses

20. An Mould (mold) Kit for ingredients shaping according to claim 1, 2, and 3, wherein: can be done automatically or manually.
